(19) United States
(12) Patent Application Publication
(10) Pub. No.: US 2026/0166887 A1
(43) Pub. Date: Jun. 18, 2026

(54) LIQUID EJECTION HEAD AND LIQUID EJECTION APPARATUS

(71) Applicant: CANON KABUSHIKI KAISHA, Tokyo (JP)

(72) Inventors: MASATOSHI OHIRA, Kanagawa (JP); YOSUKE TAKAGI, Kanagawa (JP); YASUAKI KITAYAMA, Kanagawa (JP); TOMOAKI KAMAGATA, Kanagawa (JP)

(21) Appl. No.: 19/423,182

(22) Filed: Dec. 17, 2025

(30) Foreign Application Priority Data
Dec. 18, 2024 (JP) 2024-222351

(51) Int. Cl. B41J 2/175; B41J 2/18; B41J 2/20; B41J 25/00; B41J 29/00

(52) U.S. Cl. CPC B41J 2/17596; B41J 2/18; B41J 2/20; B41J 25/005; B41J 29/00

(57) ABSTRACT

A liquid ejection head includes: a reservoir for storing a liquid; an element substrate including an ejection element for ejecting the liquid stored in the reservoir from ejection ports; a pump for circulating the liquid between the reservoir and the element substrate; and an electric circuit board configured to relay power and electric signals for driving the pump and the element substrate, wherein the pump and the electric circuit board are connected by a connector, and the electric circuit board is disposed between the reservoir and the element substrate.

### BACKGROUND

### Field of the Technology

The present disclosure relates to a liquid ejection head and a liquid ejection apparatus.

### Description of the Related Art

Japanese Patent Laid-Open No. 2022-15694 discloses a liquid ejection head having a box-shaped main body, a sub-tank mounted inside the box, and a circuit board mounted on the back.

In some liquid ejection head configurations, a circulation pump mounted on the sub-tank circulates a liquid within the liquid ejection head as countermeasures for liquid thickening, precipitation of coloring materials, and stagnation of bubbles and foreign matter in the liquid ejection head or liquid supply channel. To drive the circulation pump, a connector (electric connection portion) provided on the circuit board needs to be connected to a harness (electric wiring) extending from the sub-tank to transmit an electric signal and supply power to the circulation pump.

### SUMMARY

In a case where a circulation pump is installed in the sub-tank disclosed in Japanese Patent Laid-Open No. 2022-15694, a manufacturing process requires connecting a connector on the circuit board mounted on the back of the main body of the liquid ejection head to a harness extending from the sub-tank. However, there are space limitations on the back side of the liquid ejection head equipped with the sub-tank, and the space around the connector is narrow, reducing the workability for the connection work and potentially reducing productivity.

Therefore, the present disclosure provides a technology to suppress reduction in productivity for a liquid ejection head equipped with a sub-tank and a circulation pump.

A liquid ejection head of the present disclosure includes: a reservoir for storing a liquid; an element substrate including an ejection element for ejecting the liquid stored in the reservoir from ejection ports; a pump for circulating the liquid between the reservoir and the element substrate; and an electric circuit board configured to relay power and electric signals for driving the pump and the element substrate, wherein the pump and the electric circuit board are connected by a connector, and the electric circuit board is disposed between the reservoir and the element substrate.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic perspective view of a liquid ejection apparatus;

FIG. 1B is a block diagram showing a control system;

FIG. 2 is an exploded perspective view showing an example of a liquid ejection head;

FIG. 3 is a diagram showing an example of a connection state between an electric circuit board and an element substrate;

FIG. 4A is a schematic cross-sectional view of the liquid ejection head;

FIG. 4B is a schematic cross-sectional view of the liquid ejection head; and

FIG. 5 is a top view showing the electric circuit board.

### DESCRIPTION OF THE EMBODIMENTS

Embodiments of the present disclosure will be described below with reference to the drawings.

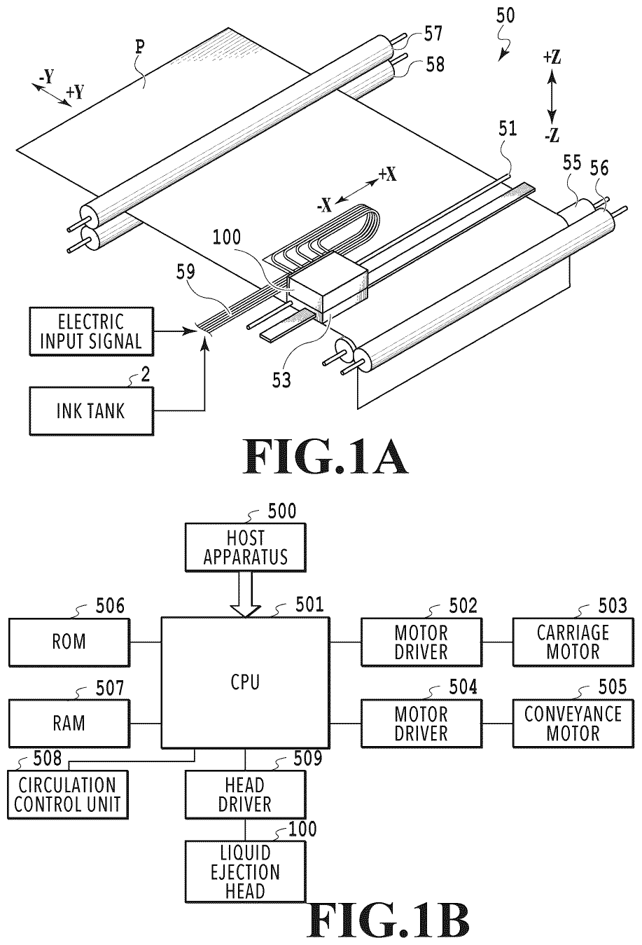

FIG. 1A is a schematic perspective view of a liquid ejection apparatus 50 using a liquid ejection head 100. FIG. 1B is a block diagram showing a control system of the liquid ejection apparatus 50. First, coordinate axes in the drawings will be described. In the drawings referred to in this specification, X and Y directions represent two directions orthogonal to each other on a horizontal plane, and a Z direction represents a vertical direction. With the liquid ejection head 100 mounted on the liquid ejection apparatus 50, a +Y direction represents the rear of the liquid ejection head 100, a −Y direction represents the front, a −X direction represents the left, a +X direction represents the right, a +Z direction represents the upper side, and a −Z direction represents the lower side. The +Y direction also represents downstream in a conveyance direction of a printing medium, and the −Y direction also represents upstream in the conveyance direction of the printing medium. The X direction will be referred to as a scanning direction as appropriate. In the following description, unless otherwise specified, the upper side, lower side, left, and right refer to the directions in a use posture in which the liquid ejection head 100 is used in a normal state.

In the present embodiment, description is given assuming that “liquid” is ink. However, the liquid that can be used in the present embodiment is not limited to ink. In other words, various printing liquids may be used as the liquid, including a treatment liquid and the like used to improve ink fixability on the printing medium, reduce gloss unevenness, or improve abrasion resistance.

In the present embodiment, description is given assuming that “printing medium” is paper used in a general liquid ejection apparatus. However, the “printing medium” is not limited as along as it is capable of accepting liquids. Other examples of “printing medium” include cloth, plastic film, metal plate, glass, ceramics, resin, wood, leather, and the like.

“Printing” does not only mean forming meaningful information such as characters and graphics, but also means forming meaningless information such as images, designs, patterns or the like. Furthermore, “printing” does not necessarily mean something that is manifested in a way that can be perceived visually by humans. In other words, “printing” also means forming a structure on a printing medium or processing the medium.

The liquid ejection apparatus 50 is a serial scan type inkjet printing apparatus that can be fitted with the liquid ejection head 100 and ejects ink from the liquid ejection head 100 to print an image on a printing medium P. The liquid ejection head 100 is mounted on a carriage 53, which moves in a main scanning direction (X direction) along a guide shaft 51. The liquid ejection head 100 performs print scanning while moving and ejecting ink.

The printing medium P is conveyed in a sub-scanning direction (+Y direction) intersecting (in this example, orthogonal to) the main scanning direction, by conveyance rollers 55, 56, 57, and 58. An ejection energy generating element (ejection element) included in an ejection unit 300 is driven by a head driver 509 in response to an input signal from an electric connection substrate. Wiring for transmitting an electric input signal required for ejection and piping for supplying ink and air are connected as a guide 59 to the liquid ejection head 100. The electric input signal is supplied from the head driver 509 through the guide 59 to supply ink from an ink tank 2 to the liquid ejection head 100 via the guide 59.

The liquid ejection apparatus 50 includes a conveyance unit (conveyance rollers 55, 56, 57, and 58) for conveying the printing medium P in the conveyance direction (+Y direction) (see FIG. 1A). The liquid ejection apparatus 50 performs a conveyance operation by driving the conveyance unit to move the liquid ejection head 100 in the scanning direction while intermittently moving the printing medium P in the conveyance direction, and performs printing by ejecting a liquid. In this way, the liquid ejection apparatus 50 performs printing on the printing medium P by alternately performing printing and conveyance operations.

The liquid ejection head 100 is capable of full-color printing using CMYK (cyan, magenta, yellow, and black) inks. A cap member (not shown) is disposed at a position off a conveyance path of the printing medium P. During non-execution of the printing operation by the liquid ejection head 100, the cap member moves relatively to a position covering the face surface of the liquid ejection head 100 where ejection ports are formed, to keep the ejection ports from drying out and perform a suction operation for filling and recovery.

A CPU (control unit) 501 controls the printing apparatus 50 based on a program such as processing procedures stored in a ROM 506. A RAM 507 is used as a work area for executing such processing. The CPU 501 controls the head driver 509 based on image data from a host apparatus 500 outside the liquid ejection apparatus 50. The CPU 501 also controls a carriage motor 503 for moving the carriage 53 via a motor driver 502, and controls a conveyance motor 505 for conveying the printing medium P via a motor driver 504. In the present embodiment, the CPU 501 reads a program stored in the ROM 506 and expands and executes the program in the RAM 507, thus allowing for ink circulation inside the liquid ejection head 100.

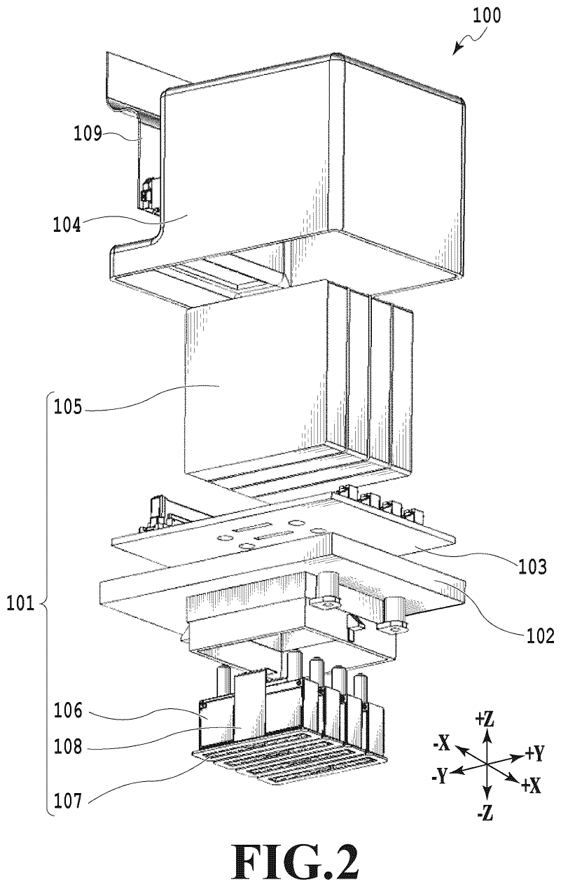

FIG. 2 is an exploded perspective view showing an example of the liquid ejection head 100 to which the present embodiment can be applied. The liquid ejection head 100 can be detachably mounted on the liquid ejection apparatus 50 capable of printing on a printing medium by ejecting a liquid by a so-called serial system. The liquid ejection head 100 is attached to the carriage 53 capable of reciprocally moving in the scanning direction (±X direction). The liquid ejection head 100 in a state of being attached to the carriage 53 can perform printing by ejecting liquid onto the printing medium P while reciprocally moving in the scanning direction (±X direction).

The liquid ejection head 100 includes four individual units 101 capable of individually ejecting liquids. The liquid ejection head 100 includes a base member 102 capable of supporting all of the individual units 101, an electric circuit board 103 disposed on the base member 102, and a cover 104 capable of covering the electric circuit board 103. In the present embodiment, the cover 104 is detachable from the base member 102. However, the cover 104 may also be fixed so as not to be easily removed from the base member 102.

Each of the four individual units 101 includes: a sub-tank 105, which functions as a reservoir capable of temporarily storing the liquid used for printing; a channel portion 106 in which a channel is formed; and an element substrate 107, which is a semiconductor device capable of ejecting the liquid. The electric circuit board 103 and each of the four element substrates 107 are connected by a flexible substrate 108. That is, in the present embodiment, four flexible substrates 108 are used.

In the liquid ejection head 100 of the present embodiment, the electric circuit board 103 is disposed between the sub-tank 105 and the element substrate 107. The electric circuit board 103 will be described in detail later.

In the present embodiment, two channels are formed inside the channel portion 106 to fluidically connect the sub-tank 105 and the element substrate 107.

The element substrate 107 has an ejection port surface on which an array of energy generating elements (for example, heaters) that generate energy to eject the liquid and an ejection port array consisting of a plurality of ejection ports for ejecting the liquid are formed along a predetermined direction. The ejection port array is formed along the conveyance direction (Y direction) of the printing medium P. Each of the plurality of energy generating elements is provided at a position corresponding to each of the plurality of ejection ports. The energy generating elements are driven to eject liquid droplets from the ejection ports. An electric signal (ejection signal) for driving the energy generating elements is generated by the control unit described above. The CPU 501 transmits the ejection signal from the main body of the liquid ejection apparatus 50 to the electric circuit board 103 through an electric connection member 109.

In the present embodiment, a flexible cable is used as the electric connection member 109. The ejection signal received by the electric circuit board 103 is transmitted to the element substrate 107 through the flexible substrate 108. The element substrate 107 is provided with a terminal capable of receiving the ejection signal. The head driver 509 (see FIG. 1B) drives the energy generating elements to eject the liquid from the ejection ports, in accordance with the ejection signal received by the element substrate 107.

Each of the four individual units 101 is fixed to the base member 102 and thus assembled to the liquid ejection head 100. The periphery of the sub-tank 105 is covered by the cover 104. The cover 104 is attached vertically from the upper side to the lower side and fixed to the base member 102.

Note that, while the four individual units 101 are used in the present embodiment, the number of the individual units 101 is not limited to four. There may be four or more individual units 101, or fewer than four individual units 101.

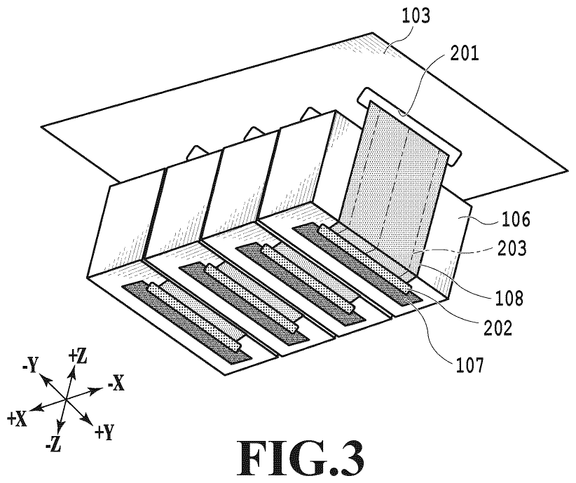

FIG. 3 is a diagram showing an example of a connection state between the electric circuit board 103 and the element substrate 107 in the present embodiment.

The electric circuit board 103 is disposed vertically above the channel portion 106 so that its front and back surfaces are horizontal during use. Therefore, the electric circuit board 103 has an upper surface facing vertically upward (+Z direction) and a lower surface facing vertically downward (−Z direction). A first opening 201 is formed in the electric circuit board 103 so as to correspond to the element substrates 107 of each color.

The flexible substrate 108 is disposed so as to pass through the first opening 201. An end portion (not shown in FIG. 3) of the flexible substrate 108 is connected to approximately the center of the upper surface of the electric circuit board 103 in the Y direction. The flexible substrate 108 passes through the first opening 201 from the upper surface of the electric circuit board 103 and extends along the side surface (surface facing the −X direction in FIG. 2) of the channel portion 106.

The element substrate 107 is attached to the bottom surface (surface facing the −Z direction in FIG. 2) of the channel portion 106. The flexible substrate 108 extends from the side surface of the channel portion 106 along the bottom surface thereof so as to bend at about 90°. The element substrate 107 has a rectangular shape with long and short sides when viewed from the bottom. An electrical contact section to which the end portion of the flexible substrate 108 is connected is provided on the bottom surface (surface facing the −Z direction in FIG. 3) of the element substrate 107. The electrical contact section is provided along the width direction (Y direction in FIG. 3) of the flexible substrate 108 at the end portion of the flexible substrate 108 in the extending direction.

More specifically, the electrical contact section is formed by arraying a plurality of terminals along the width direction of the flexible substrate 108 at the end portion of the flexible substrate 108 in the extending direction. The flexible substrate 108 contains inside a plurality of wirings 203 (for example, copper foil). The electrical contact section is sealed with a sealant 202 after the element substrate 107 and the flexible substrate 108 are electrically connected. In the flexible substrate 108, the individual wirings 203 are linearly arranged along the extending direction of the flexible substrate 108.

This arrangement allows the area for arranging the wirings 203 in the bottom face portion of the liquid ejection head 100 to be kept relatively compact. This means that the bottom face portion of the liquid ejection head 100 can be downsized, and the entire liquid ejection head can be downsized. As described above, in the bottom face portion of the liquid ejection head 100, the electrical contact section of each wiring is disposed linearly along the extending direction of the flexible substrate 108 without changing the extending direction of the wiring 203, in consideration of downsizing of the liquid ejection head 100 and production costs.

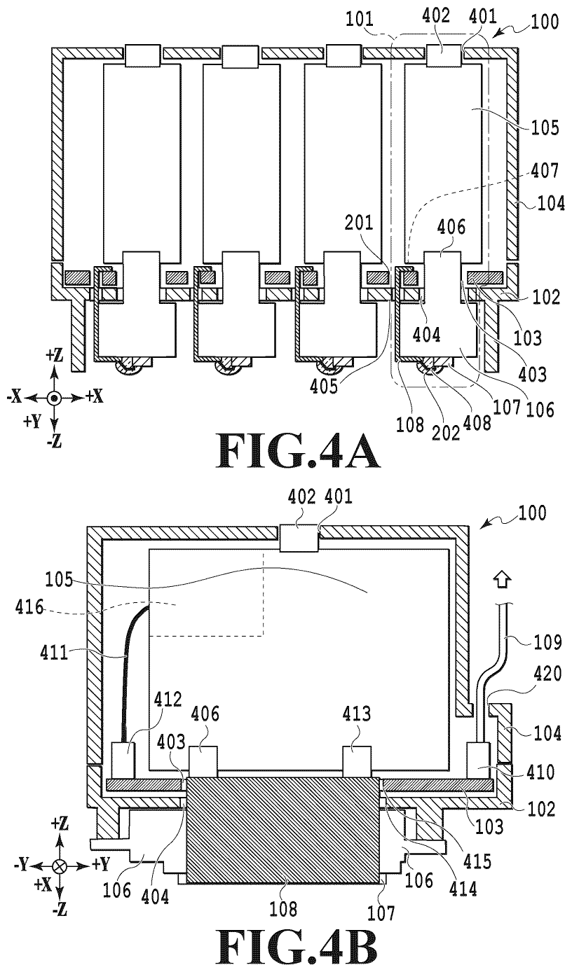

FIGS. 4A and 4B are schematic cross-sectional views of the liquid ejection head 100 according to the present embodiment. FIGS. 4A and 4B show the liquid ejection head 100 in a state of being attached to the liquid ejection apparatus 50. FIG. 4A shows the liquid ejection head 100 sectioned along a plane parallel to XZ plane. FIG. 4B shows the liquid ejection head 100 sectioned along a plane parallel to YZ plane.

As shown in FIG. 4A, a second opening 401 is formed in a top surface of the cover 104. The sub-tank 105 is provided with a supply port 402 through which the liquid is supplied from the main tank (not shown). The supply port 402 is provided inside the second opening 401. The electric circuit board 103 is provided with a third opening 403.

The base member 102 is provided with a fourth opening 404 and a sixth opening 414 (see FIG. 4B), through which part of the channel portion 106 passes. The channel portion 106 is provided with a supply channel 406 connected to the sub-tank 105 for supplying the liquid from the sub-tank 105 to the element substrate 107. The supply channel 406 is formed so as to pass through the third opening 403 and the fourth opening 404. The channel portion 106 also has a collecting channel 413 formed therein to collect the liquid from the element substrate 107 to the sub-tank 105 upon circulation of the liquid. The collecting channel 413 is formed so as to pass through the sixth opening 414 provided in the base member 102 and a seventh opening 415 provided in the electric circuit board 103. The sub-tank 105 and the channel portion 106 are connected to each other through the supply channel 406 and the collecting channel 413.

An electric connection portion 407 (specifically, a plurality of terminals) to which the end portion of the flexible substrate 108 is connected is provided on the upper surface of the electric circuit board 103. The flexible substrate 108 and the element substrate 107 are connected by a wire 408. The wire 408 is sealed with the sealant 202.

In a state where the liquid ejection head 100 is mounted on the liquid ejection apparatus 50, the electric circuit board 103 and the element substrate 107, which has the ejection ports capable of ejecting the liquid, are disposed parallel to each other (almost horizontally).

The flexible substrate 108 is disposed so as to pass through the first opening 201 provided in the electric circuit board 103 and the fifth opening 405 provided in the base member 102 from the electric connection portion 407 provided on the upper surface of the electric circuit board 103. The flexible substrate 108 is disposed along the side surface and bottom surface of the channel portion 106, and is connected to the wire 408. The terminals of the flexible substrate 108 and the terminals provided on the element substrate 107 are connected by wire bonding using the wires 408.

In a case of performing printing with the liquid ejection head 100, the liquid used for printing is supplied from the main tank (not shown) to the sub-tank 105 through the supply port 402. The liquid is temporarily stored in the sub-tank 105. With the sub-tank 105 attached to the liquid ejection head 100, the sub-tank 105 is disposed vertically above the electric circuit board 103. The liquid stored in the sub-tank 105 is supplied to the element substrate 107 through the supply channel 406.

As an ejection signal for ejecting the liquid is transmitted to the energy generating element provided on the element substrate 107 through the flexible substrate 108 and the wire 408, the liquid is ejected from the ejection port. Any liquid not ejected from the element substrate 107 is collected into the sub-tank 105 through the collecting channel 413.

In the present embodiment, as shown in FIG. 4B, a first connector 410 is provided on the upper surface of the electric circuit board 103. The first connector 410 can connect to the electric connection member 109 for transmitting an electric signal (for example, an ejection signal) generated in the main body of the liquid ejection apparatus 50 to the electric circuit board 103. The first connector 410 is provided at a +Y-direction end portion of the surface of the electric circuit board 103 facing the +Z direction. An eighth opening 420 is provided in the cover 104 at a position facing the first connector 410, and the electric connection member 109 and the first connector 410 are connected through the eighth opening 420. During the manufacturing process of the liquid ejection head 100, the electric connection member 109 and the first connector 410 are connected before the sub-tank 105 and the cover 104 are attached. This allows securing ample working space for easy connection.

In the present embodiment, the liquid ejection head 100 is configured to circulate the liquid inside, in order to achieve stable ejection performance even if the viscosity of the liquid is increased. A pump 416 for circulating the liquid is provided inside the sub-tank 105. An original signal for driving the pump 416 is generated by a pump control unit (for example, the CPU 501). This original signal is inputted to the first connector 410 provided on the upper surface of the electric circuit board 103 from the main body of the liquid ejection apparatus 50 through the electric connection member 109.

In the electric circuit board 103, the original signal for driving the pump 416 is transmitted to a second connector 412 provided on the upper surface of the electric circuit board 103 via a circuit provided on the electric circuit board 103. With a harness 411 connected to the second connector 412 (connector connection), the original signal is transmitted to the pump 416 provided inside the sub-tank 105 through the harness 411. The harness 411 is detachable from the second connector 412.

With this configuration, as a drive signal for driving the pump 416 is inputted to the first connector 410 through the electric connection member 109, the drive signal is transmitted to the second connector 412 through a circuit provided on the electric circuit board 103. The drive signal is then transmitted to the pump 416 through the harness 411. As the pump 416 is driven by this drive signal, the liquid is supplied from the pump 416 to the element substrate 107 through the supply channel 406, and then collected by the pump 416 from the element substrate 107 through the collecting channel 413. Circulating the liquid inside the liquid ejection head by the pump 416 can reduce thickening of the liquid, precipitation of coloring materials, stagnation of foreign matter, and the like in the liquid ejection head.

In such a liquid circulation system, by configuring the supply channel 406 and the collecting channel 413 to pass through the openings provided in the base member 102 and the electric circuit board 103, the entire liquid ejection head can be downsized even if the plurality of individual units 101 are included.

In the present embodiment, the harness 411 is connected to the second connector 412 after the sub-tank 105 is mounted and before the cover 104 is attached. The work of connecting the harness 411 is difficult if there are many obstacles around the second connector 412. However, in the present embodiment, the electric circuit board 103 is located directly below the sub-tank 105, and the base member 102 has no walls surrounding the second connector 412, resulting in a configuration with good workability.

Furthermore, in the present embodiment, the second connector 412 extends linearly and vertically upward from the upper surface of the electric circuit board 103. The harness 411 extends from the upper side to the lower side in the vertical direction. This allows an operator to easily connect the harness 411 to the second connector 412 so as to face vertically downward. This configuration allows the harness 411 and second connector 412 to be connected without the need for complicated work, thereby suppressing reduction in productivity.

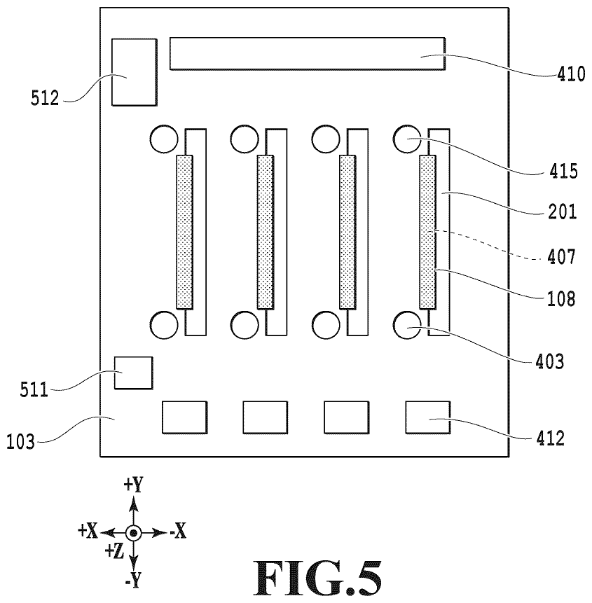

FIG. 5 is a top view of the electric circuit board 103 to which the present embodiment can be applied. An electric connection region and an electric component mounting region are provided on the upper surface of the electric circuit board 103. In the present embodiment, the electric connection region includes the electric connection portion 407, the first connector 410, and the second connector 412. The electric component mounting region includes a memory device 511 that stores information about the liquid ejection head 100, and a pump drive circuit 512 that converts an original signal for driving the pump into a drive signal. In the present embodiment, the electric connection region and the electric component mounting region are thus integrated on the upper surface of the electric circuit board 103.

The electric circuit board 103 also includes the third opening 403 through which the supply channel 406 (see FIGS. 4A and 4B) passes and the seventh opening 415 through which the collecting channel 413 (see FIG. 4B) passes. The electric connection portion 407 connecting the flexible substrate 108 and the electric circuit board 103 is preferably sealed with a sealant (not shown in FIG. 5). This configuration ensures electrical safety.

As such, with the liquid ejection head 100 of the present embodiment, the electric circuit board 103 is disposed between the sub-tank 105, which serves as the reservoir, and the element substrate 107. This makes it possible to reduce the time required for assembly in the production process for the liquid ejection head equipped with the sub-tank and the pump 416, thereby suppressing reduction in productivity.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-222351, filed Dec. 18, 2024, which is hereby incorporated by reference herein in its entirety.

What is claimed is:

1. A liquid ejection head comprising:
a reservoir for storing a liquid;
an element substrate including an ejection element for ejecting the liquid stored in the reservoir from ejection ports;
a pump for circulating the liquid between the reservoir and the element substrate; and
an electric circuit board configured to relay power and electric signals for driving the pump and the element substrate, wherein
the pump and the electric circuit board are connected by a connector, and
the electric circuit board is disposed between the reservoir and the element substrate.

2. The liquid ejection head according to claim 1, wherein the pump is provided inside the reservoir.

3. The liquid ejection head according to claim 1, further comprising:
a flexible substrate connecting the electric circuit board to the element substrate, wherein
the electric circuit board has a first opening through which the flexible substrate passes.

4. The liquid ejection head according to claim 1, further comprising:
a cover covering the reservoir, wherein
the cover has a second opening through which a supply port provided in the reservoir passes.

5. The liquid ejection head according to claim 1, further comprising:
a channel portion fluidically connecting the reservoir and the element substrate, wherein
the electric circuit board has a third opening through which the channel portion passes.

6. The liquid ejection head according to claim 5, wherein
the channel portion includes a first channel for supplying the liquid from the reservoir to the element substrate and a second channel for collecting the liquid from the element substrate to the reservoir.

7. The liquid ejection head according to claim 5, further comprising:
a base member configured to support the electric circuit board, wherein
the base member has a fourth opening through which the channel portion passes.

8. The liquid ejection head according to claim 1, wherein
in a posture of the liquid ejection head in use,
the electric circuit board and the element substrate are horizontally disposed, and
the pump has a harness connected vertically from above to a connector provided on an upper surface of the electric circuit board.

9. The liquid ejection head according to claim 3, wherein a connection portion between the element substrate and the flexible substrate is sealed with a sealant.

10. The liquid ejection head according to claim 5, comprising:
a plurality of the reservoirs and a plurality of the element substrates corresponding to the plurality of reservoirs, respectively, wherein
the electric circuit board has a plurality of the third openings corresponding to the plurality of reservoirs, respectively.

11. A liquid ejection apparatus capable of mounting a liquid ejection head including
a reservoir for storing a liquid,
an element substrate including an ejection element for ejecting the liquid stored in the reservoir from ejection ports,
a pump for circulating the liquid between the reservoir and the element substrate, and
an electric circuit board configured to relay power and electric signals for driving the pump and the element substrate, wherein
the pump and the electric circuit board are connected by a connector, and
the electric circuit board is disposed between the reservoir and the element substrate.

12. The liquid ejection apparatus according to claim 11, configured to print an image on a printing medium by alternately repeating print scanning for moving the liquid ejection head in a scanning direction while ejecting the liquid, and a conveyance operation for conveying the printing medium in a direction intersecting the scanning direction.
